(19) United States
(12) Patent Application Publication
(10) Pub. No.: US 2015/0268408 A1
(43) Pub. Date: Sep. 24, 2015

(54) LED CLASSIFICATION METHOD, LED CLASSIFICATION DEVICE, RECORDING MEDIUM, AND LIQUID-CRYSTAL DISPLAY DEVICE

(71) Applicant: SHARP KABUSHIKI KAISHA, Osaka (JP)

(72) Inventors: Masayuki Ohta, Osaka-shi (JP); Masataka Miyata, Osaka-shi (JP); Kazuo Tamaki, Osaka-shi (JP); Takashi Nakanishi, Osaka-shi (JP); Kenichi Kurita, Osaka-shi (JP); Kiyoshi Nagata, Osaka-shi (JP); Masaki Tatsumi, Osaka-shi (JP)

(73) Assignee: SHARP KABUSHIKI KAISHA, Osaka-shi, Osaka (JP)

(21) Appl. No.: 14/435,334

(22) PCT Filed: Oct. 8, 2013
(86) PCT No.: PCT/JP2013/077382

§ 371 Date: Apr. 13, 2015

(30) Foreign Application Priority Data
Oct. 15, 2012 (JP) 2012-228160

(51) Int. Cl. F21V 8/00; G01J 3/50

(52) U.S. Cl. CPC G02B 6/0073; G01J 3/506

(57) ABSTRACT

An LED classification device (21) classifies LEDs, the LEDs each including a combination of an LED element that emits a primary light and a phosphor that, upon excitation by the primary light, emits a secondary light having a longer wavelength than the primary light, the LEDs each emitting a combined light of the primary light and the secondary light, those ones of the LEDs whose primary lights having their chromaticities falling within a predetermined chromaticity range being classified as LEDs for use in a backlight of a liquid crystal display apparatus. A coefficient calculating section (26) and a corrected chromaticity calculating section (27) calculate, for all of the LEDs to be classified, correction values for the chromaticities as obtained on the assumption that the primary lights have traveled through a color filter of the liquid crystal display apparatus, and correct chromaticities by subtracting the correction values from chromaticities obtained for all of the LEDs to be classified, respectively. A chromaticity rank classification section (28) classifies the LEDs according to chromaticity rank on the basis of the corrected chromaticities.

### TECHNICAL FIELD

The present invention relates to an LED classification method for classifying a plurality of LEDs (light-emitting diodes) on the basis of their chromaticity distribution as to whether or not they can be used in a backlight of a liquid crystal display apparatus.

### BACKGROUND ART

In recent years, as backlights of liquid crystal display apparatuses, backlights using long-lived and micropower LEDs as light sources are becoming widely used. Such a backlight normally uses white LEDs. A white LED is generally constituted by a combination of a blue LED and a phosphor. Such a white LED gives a white light through a color mixture of (a) a blue light emitted from the blue LED chip and (b) light emitted by the phosphor's being excited by the blue light. For example, a white LED using a green and a red phosphors gives a white light through a color mixture of (a) a green and a red lights produced by the green and the red phosphors' being excited by a blue light and (b) the blue light.

In order for such a white LED to be used in a backlight, it is necessary to apply a phosphor according to the display characteristics of a liquid crystal panel in a liquid crystal display apparatus so that the white LED emits a desired color of white.

For example, Patent Literature 1 discloses a method that makes it possible to easily and quickly provide to a manufacturing process a phosphor capable of converting a luminescent color of white produced by a blue LED and a phosphor into a more even tone of color. In this method, with respect to a content correlated with a relationship between light source color information and required luminescent color information of a white LED through a coefficient associated with a phosphor material, a phosphor material associated with a coefficient found by applying light source color information and required luminescent color information of a particular white LED as presented by a client is specified. This makes it possible to, without the need to wait for a light-emitting element to be actually obtained, quickly obtain, as phosphor-specifying information, the type of a phosphor raw material, the composition ratio of thereof, the mixing ratio (part(s) by weight) thereof with respect to the base material, etc. that substantially satisfy the requested luminescent color information as requested by the client.

Meanwhile, Patent Literature 2 discloses a method in which a white LED can be quickly manufactured by calculating such a mixing concentration of a phosphor by software in a non-trial-and-error manner that the white LED has high color reproducibility. In this method, first, a process of causing a mixed-lighting spectrum and a standard spectrum to approximate to each other is performed, the mixed-lighting spectrum having been obtained through a mixture of (a) light from two types of phosphor whose concentrations have been adjusted and (b) light from an LED. Next, a process of calculating the amount of space that is surrounded by the chromaticity coordinates of the three primary colors into which the mixed-lighting spectrum has been divided by a color filter and calculating the chromaticity coordinate position of a white light constituted by the three primary colors. Such a process is computationally executed.

Further, Patent Literature 3 describes a backlight adjusting a blue-light leak of a phosphor layer in a white LED in accordance with a blue wavelength of a blue LED included in the white LED.

Furthermore, Patent Literature 4 discloses a method for improving uniformity of a display on a display panel irradiated with light from a backlight. This method for example includes: estimating a filter function of a transmissive display component that transmits light emitted by the backlight; and, for a plurality of light emitters, estimating filtered chromaticity data corresponding to the filter function.

### CITATION LIST

Patent Literature 1

Japanese Patent Application Publication, Tokukai, No. 2001-107036 A (Publication Date: Apr. 17, 2001)

Patent Literature 2

Japanese Patent Application Publication, Tokukai, No. 2010-93237 A (Publication Date: Apr. 22, 2010)

Patent Literature 3

Japanese Translation of Patent International Application, Tokuhyo, No. 2012-503215 A (Publication Date: Feb. 2, 2012)

Patent Literature 4

Japanese Translation of Patent International Application, Tokuhyo, No. 2011-504605 A (Publication Date: Feb. 10, 2011)

### SUMMARY OF INVENTION

### Technical Problem

Each of these methods disclosed in Patent Literatures 1 and 2 is a method in which the concentration etc. of a phosphor during the manufacture of a white LED is determined. Further, the method disclosed in Patent Literature 3 is a method in which blue light during the manufacture of a white LED is adjusted.

However, in the case of a backlight using a plurality of white LEDs each constituted by a combination of a blue LED and a phosphor, forming a phosphor layer so that the phosphor is used in a desired concentration and amount is very difficult even with such an optimum determination of the concentration etc. of the phosphor. For this reason, there is nonuniformity in the concentration and amount of the phosphor during the manufacture among the white LEDs. Further, since there are also variations in the characteristics of the blue LEDs and the light-emitting layers among products, there are variations in the peak wavelength of blue lights among the white LEDs. This causes variations in the balance of light intensity between the excitation lights of the phosphors and the blue lights of the blue LEDs, so there is also undesirably variation in chromaticity among the white LEDs.

Direct use of such chromaticity-varied white LEDs in a backlight presents such inconvenience that there is nonuniformity in display colors within a display surface. Conventionally, such inconvenience has been overcome by selecting, for use in a backlight, only white LEDs so classified according to chromaticity rank that their chromaticity distribution falls within a predetermined range.

FIG. 10 is a diagram showing an example of such chromaticity rank classification. As shown in FIG. 10, only white LEDs having their chromaticity distributed within a rectangular frame F representing the predetermined range are selected for use. The frame F is divided into smaller ranges configured such that demarcations can be made according to chromaticity rank for each division. In the frame F, the chromaticity of a group of white LEDs whose blue light components have short peak wavelengths is distributed in a range D11 indicated by a solid line. In the range D11, the peak wavelength is 444.7 nm, and the average chromaticity AVE11 is located in a position indicated by a solid circle. Meanwhile, in the frame F, the chromaticity of a group of white LEDs whose blue light components have long peak wavelengths is distributed in a range D12 indicated by a broken line. In the range D12, the peak wavelength is 446.2 nm, and the average chromaticity AVE12 is located in a position indicated by a broken circle.

However, even as a result of selecting white LEDs that emit lights whose chromaticity falls within a predetermined range, a range of variation in the chromaticity of the white LEDs on a panel display after transmission of the lights through the liquid crystal panel is enlarged. This is because the chromaticity of the white LEDs on the panel display is divided by the influence of the color filter in particular into groups falling within a range of variation in chromaticity according to the peak wavelengths of the blue lights. This leads to the emergence of white LEDs that deviate from the desired chromaticity rank range on the panel display of the liquid crystal panel. A reason for this is explained in detail below.

First, the maximum value of the luminance of a blue light on the display surface of a liquid crystal panel is determined by the transmittance of a color filter (blue filter) of the liquid crystal panel through which the blue light travels (including a decrease in luminance that occurs when the blue light travels through an optical member such as an optical sheet or a diffuser between the LED light source and the liquid crystal panel) and the light intensity of the blue light emitted from the blue LED of a white LED (Light Intensity×Transmittance). On the other hand, even a white LED having its chromaticity classified into a predetermined chromaticity rank range as described above has a deviation of about ±5 nm from the peak wavelength of the blue light component. Further, the shorter the wavelength is, the lower the transmittance of the color filter (blue filter) tends to be. For this reason, such a deviation from the peak wavelength of the blue light component causes a change in the maximum value of the luminance of a blue light on the display surface of a liquid crystal panel.

FIG. 11 is a graph showing a relationship between the emission spectrum of the blue LED of a white LED and the transmission characteristics of a color filter (blue filter). In FIG. 11, the vertical axis represents the transmittance of the color filter and the intensity of light emitted by the blue LED.

As shown in FIG. 11, if the peak wavelength of the blue light component is centered at 450 nm, the peak wavelength deviates by +5 nm to 455 nm or deviates by −5 nm to 445 nm. In FIG. 11, the spectrum of a blue light having a peak wavelength of 455 nm is indicated by a broken line, and the spectrum of a blue light having a peak wavelength of 445 nm is indicated by an alternate long and short dash line. Those portions (shaded in FIG. 11) of the spectra of the blue lights which exceed the transmittance of the blue filter are cut.

For this reason, the amount of light that is cut by the blue filter varies between the blue light having a peak wavelength of 455 nm and the blue light having a peak wavelength of 445 nm. Specifically, the shorter the peak wavelength of a blue light is, the lower the transmittance of a blue filter becomes and, accordingly, the larger the amount of light that is cut by the blue filer becomes. Therefore, when a white light containing a blue light having a short peak wavelength travels through a color filter, the chromaticity of the white light shifts toward the yellow side to the extent that the amount of the blue light is small. Moreover, due to the influence of visual sensitivity, there is a further decrease in blue light component (i.e. there is an increase in ratio of a light component by the phosphor with respect to the light component of the blue light).

FIG. 12 is a graph showing the emission spectra of a plurality of white LEDs of the same chromaticity. FIG. 13 is a diagram showing a chromaticity rank range of lights emitted by white LEDs and a chromaticity rank range of the emitted lights having traveled through a liquid crystal panel.

The respective spectra of the white LEDs as shown in FIG. 12 are out of phase in blue light peak wavelength from one another, the white LEDs are of the same chromaticity in the frame F shown in FIG. 13. When lights emitted by the white LEDs travel through a color filter (blue filter), the amount of blue light is cut according to transmission characteristics. This causes the chromaticity distribution to shift toward a higher chromaticity. In this case, for a white LED the peak wavelength of whose blue light component is a center value (450 nm in the case shown in FIG. 11), the chromaticity spreads over a frame Ftyp shifted from the frame F in such a direction that the x value and the y value increase. For a white LED the peak wavelength of whose blue light component is shorter than the center value, the chromaticity spreads over a frame Fmin shifted further than the frame Ftyp in such a direction that the x value and the y value increase. On the other hand, for a white LED the peak wavelength of whose blue light component is longer than the center value, the chromaticity spreads over a frame Fmax shifted further than the frame Ftyp in such a direction that the x value and the y value decrease.

In order to avoid such inconvenience that the chromaticity shifts toward yellow in such a case where the peak wavelength of a blue light component is short, it is necessary to make a white balance adjustment to adjust the balance between the maximum brightness of a red and a green lights and the maximum brightness of a blue light that has undesirably been lower than the desired brightness. However, such a white balance adjustment creates a new problem of an overall decrease in display luminance of the liquid crystal panel.

In order to solve this problem, Patent Literature 4 discloses a method for estimating, for a plurality of light emitters, filtered chromaticity data corresponding to estimated filter functions, but fails to give consideration to cutting of blue light with a color filter.

The present invention has been made in view of the foregoing problems, and it is an object of the present invention to provide white LEDs that do not raise the need to make a big white balance adjustment that leads to a decrease in luminance of a display on a liquid crystal panel and that have been selected so that a variation in chromaticity on the panel display falls within a desired range.

### Solution to Problem

A method for classifying LEDs according to one aspect of the present invention is a method for classifying LEDs, the LEDs each including a combination of an LED element that emits a primary light and phosphor that, upon excitation by the primary light, emits a secondary light having a longer wavelength than the primary light, the LEDs each emitting a combined light of the primary light and the secondary light, those ones of the LEDs whose primary lights have their chromaticities falling within a predetermined chromaticity range being classified as LEDs for use in a backlight of a liquid crystal display apparatus, the method including: a chromaticity predicting step of predicting, for all of the LEDs to be classified, the chromaticities of the primary lights having traveled through a color filter in a liquid crystal panel provided in the liquid crystal display apparatus; and a chromaticity rank classification step of classifying the LEDs according to chromaticity rank on a basis of the predicted chromaticities.

Further, an LED classification device according to one aspect of the present invention is an LED classification device for classifying LEDs, the LEDs each including a combination of an LED element that emits a primary light and phosphor that, upon excitation by the primary light, emits a secondary light having a longer wavelength than the primary light, the LEDs each emitting a combined light of the primary light and the secondary light, those ones of the LEDs whose primary lights having their chromaticities falling within a predetermined chromaticity range being classified as LEDs for use in a backlight of a liquid crystal display apparatus, the LED classification device including: a chromaticity predicting section for predicting, for all of the LEDs to be classified, the chromaticities of the primary lights having traveled through a color filter in a color filter provided the liquid crystal display apparatus; and a chromaticity rank classification section for classifying the LEDs according to chromaticity rank on a basis of the predicted chromaticities.

Further, a liquid crystal display apparatus according to one aspect of the present invention is a liquid crystal display apparatus including: a liquid crystal panel; a plurality of linear light sources having a plurality of LEDs and provided adjacent to each other; a light guide plate having at least one edge side on which emitted lights from the linear light sources are incident and planarly radiating the emitted lights onto the liquid crystal panel, the LED being selected to be mounted on the linear light sources so that the chromaticities of transmitted lights obtained as a result of the emitted lights from the respective linear light sources having traveled through the light guide plate and then through the liquid crystal panel match in a position closer to a light entrance side of the light guide plate than a central part between an edge of the light guide plate on the light entrance side and an edge of the light guide plate opposite to the light-entrance-side edge.

### Advantageous Effects of Invention

An aspect of the present invention makes it possible to easily select LEDs that do not need to be made lower in luminance even when mounted in a backlight.

### BRIEF DESCRIPTION OF DRAWINGS

FIG. 1 is a perspective view showing a configuration of a liquid crystal display apparatus including a backlight having LEDs that are classified by an LED classification method according to an embodiment of the present invention.

FIG. 2 is a perspective view showing a configuration of another liquid crystal display apparatus including a backlight having LEDs that are classified by an LED classification method according to an embodiment of the present invention.

FIG. 3 is a graph showing the transmission spectra of a color filter in each of the liquid crystal display apparatuses.

FIG. 4 is a longitudinal sectional view showing a configuration of each of the LEDs.

FIG. 5 is a graph showing the emission spectrum of each of the LEDs.

FIG. 6 is a block diagram showing a configuration of an LED classification device for achieving the LED classification method.

FIG. 7 is a graph showing amounts of change in chromaticity after the transmission of a blue light through a color filter with respect to amounts of shift in peak wavelength from the reference wavelength of peak wavelengths of blue lights from the LEDs that are to be classified.

FIG. 8 is a diagram showing chromaticity rank classification according to corrected chromaticity converted by the LED classification device into values after color filter transmission.

FIG. 9 is a flow chart showing steps of a process in which the LED classification device classifies LEDs.

FIG. 10 is a diagram showing conventional chromaticity rank classification of white LEDs.

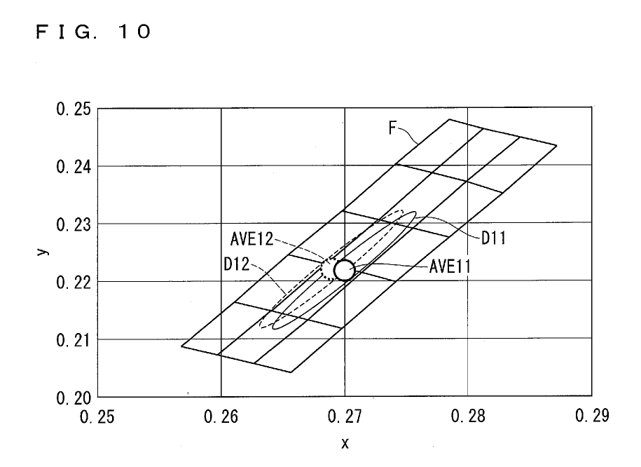

FIG. 11 is a graph showing a relationship between the emission spectrum of the blue LED of a white LED and the transmission characteristics of a color filter.

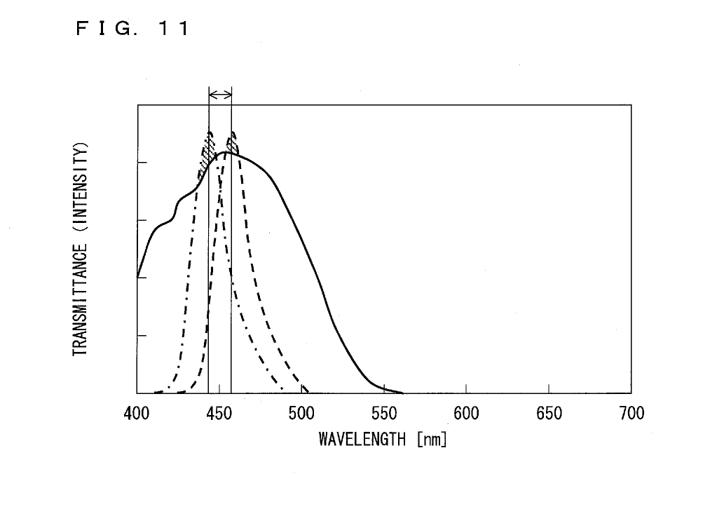

FIG. 12 is a graph showing the emission spectrum of a plurality of white LEDs of the same chromaticity according to the chromaticity rank classification of FIG. 10.

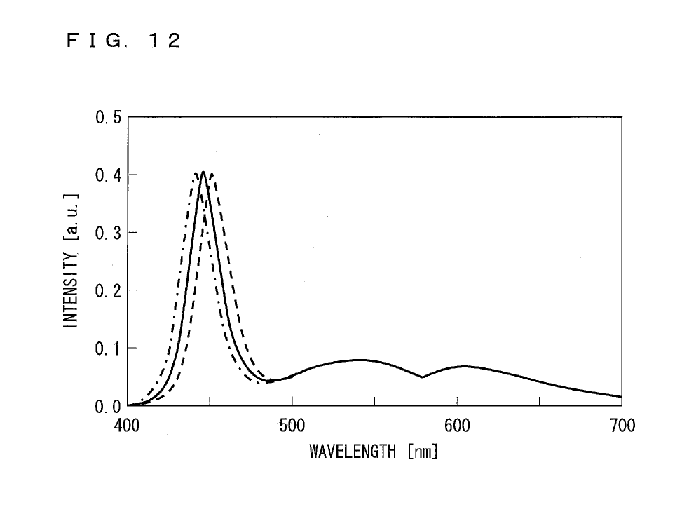

FIG. 13 is a diagram showing a chromaticity rank range of lights emitted by white LEDs and a chromaticity rank range of the emitted lights having traveled through a liquid crystal panel.

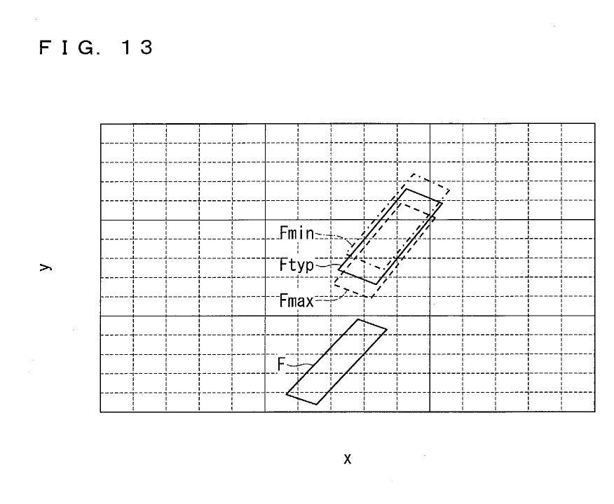

FIG. 14 is a perspective view showing a configuration of a liquid crystal display apparatus including a backlight having LEDs that are classified by an LED classification method according to another embodiment of the present invention.

FIG. 15 is a diagram showing a distribution of a blue component, in different regions on the liquid crystal panel, of beams of light respectively emitted from two LED bars (light sources) used in a backlight of the liquid crystal display apparatus of FIG. 14.

FIG. 16 is a set of graphs (a) and (b), (a) being a graph showing an emission spectrum of light from one of the LED bars according to the distribution of a blue component shown in FIG. 15, (b) being a graph showing an emission spectrum of the other of the LED bars according to the distribution of a blue component shown in FIG. 15.

FIG. 17 is a graph showing a relationship between the distance from each of the two LED bars and the peak height of the blue component of light from each of these LED bars.

FIG. 18 is a set of graphs (a) and (b) showing relationships between the distance from each of the two LED bars and the chromaticities x and y of two beams of light from the two LED bars in the backlight, respectively, the two LED bars using LEDs so chromaticity-corrected that there is no difference in chromaticity between the two beams of light in a central part of a liquid crystal panel provided in the liquid crystal display apparatus of FIG. 14.

FIG. 19 is a set of graphs (a) and (b) showing relationships between the distance from each of the two LED bars and the chromaticities x and y of two beams of light from the two LED bars in the backlight, respectively, the two LED bars using LEDs so chromaticity-corrected that there is no difference in chromaticity between the two beams of light in regions on the liquid crystal panel near the two LED bars.

### DESCRIPTION OF EMBODIMENTS

### Embodiment 1

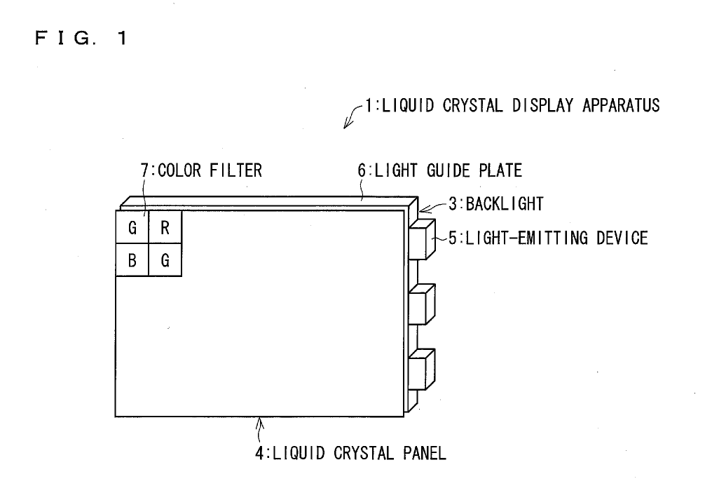

An embodiment of the present invention is described below with reference to FIGS. 1 through 9.

[Liquid Crystal Display Apparatus]

(Configuration of a Liquid Crystal Display Apparatus)

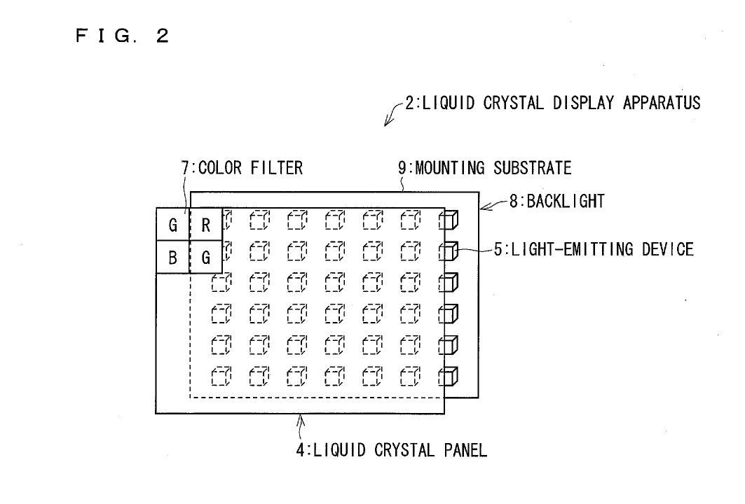

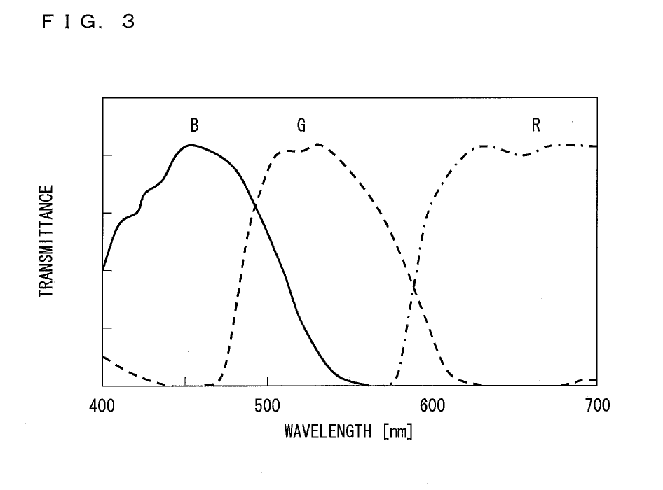

FIG. 1 is a perspective view schematically showing a configuration of a liquid crystal display apparatus 1 according to the present embodiment. FIG. 2 is a perspective view schematically showing a configuration of another liquid crystal display apparatus 2 according to the present embodiment. FIG. 3 is a graph showing the transmission spectra of a color filter in each of the liquid crystal display apparatuses 1 and 2.

As shown in FIG. 1, the liquid crystal display apparatus 1 includes a backlight 3 and a liquid crystal panel 4.

The backlight 3 is an edge-light backlight, placed on the back side of the liquid crystal panel 4, which illuminates the whole surface of the liquid crystal panel 4, and has a plurality of light-emitting devices 5 and a light guide plate 6. The light-emitting devices 5 are white LEDs, mounted at predetermined intervals on the sides of the light guide plate 6, which emits light toward the light guide plate 6. As mentioned above, each of the white LEDs includes a blue LED and a red and a green phosphors that are excited by blue light from the blue LED. The light guide plate 6 deflects lights emitted from the light-emitting devices 5 so that the lights exit toward the light crystal panel 4.

The liquid crystal panel 4, constituted by filling the space between two opposed transparent substrates with liquid crystals, changes the transmittance of light from the backlight 3 by changing the alignment of the liquid crystals in units of matrices of pixels. Further, the liquid crystal panel 4 has a color filter 7 placed on the display surface side. The color filter 7 has filters formed for their respective colors of red (R), green (G), and blue (B) for every three subpixels constituting a pixel, and the filters have transmission spectra shown in FIG. 3. By the light's traveling through each of the filters, the light of color of that filter can be emitted. In the liquid crystal panel 4, the transmittance of that part of the liquid crystal layer which corresponds to a subpixel is separately adjusted on the basis of a light color component ratio of red (R), green (G), and blue (B) corresponding to the color of each pixel as determined for each display image, so that each pixel displays a color that it is supposed to display.

As shown in FIG. 2, the liquid crystal display apparatus 2 includes a backlight 8 and the liquid crystal panel 4.

The backlight 8 is a direct backlight, placed on the back side of the liquid crystal panel 4, which illuminates the whole surface of the liquid crystal panel 4, and has a plurality of light-emitting devices 5 and a mounting substrate 9. The light-emitting devices 5 are mounted at predetermined intervals on the whole surface of the mounting substrate 9 and emit direct light to the liquid crystal panel 4. Since this backlight 8 can modulate brightness for each small region (e.g., a pixel), it is excellent in energy saving and can increase the contrast ratio between light and dark.

(Configuration of an LED)

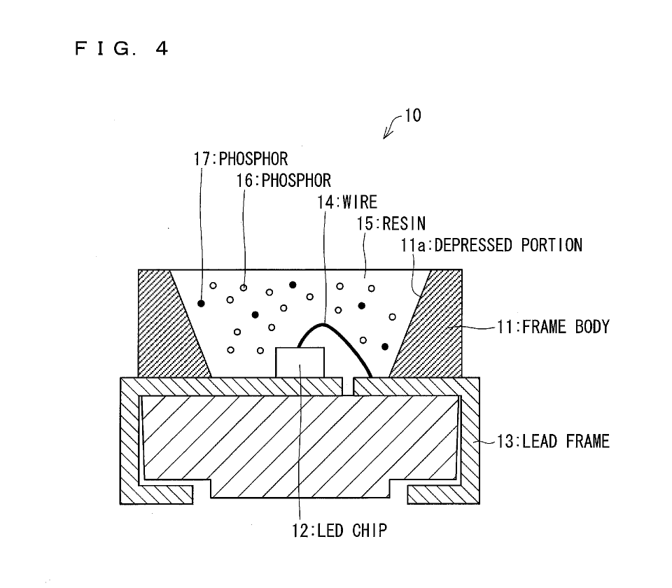

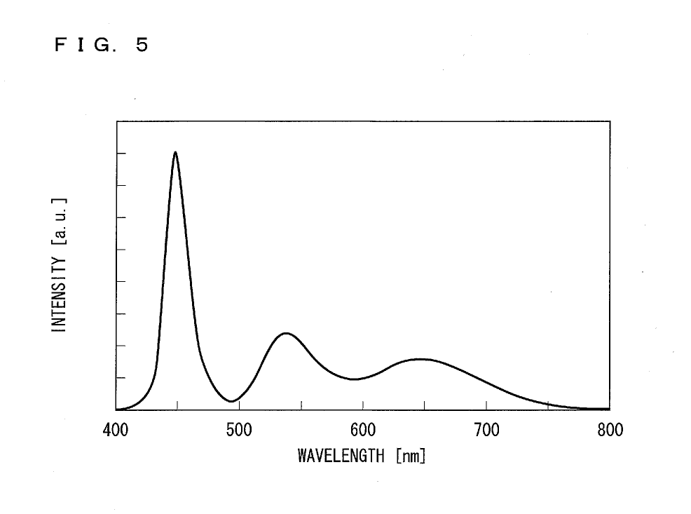

FIG. 4 is a longitudinal sectional view showing a configuration of an LED 10 as a light-emitting device 5 to be used in the aforementioned backlights 3 and 8. FIG. 5 is a graph showing the emission spectrum of the LED 10.

The LED 10 shown in FIG. 4 is a white LED that is used as a light-emitting device 5, and includes a frame body 11, an LED chip 12, a lead frame 13, a wire 14, a resin 15, and phosphors 16 and 17.

The frame body 11 is placed on the lead frame 13. Further, the frame body 11 is made of a nylon-based material and has a depressed portion 11a. The depressed portion 11a has an inclined surface formed as a reflecting surface that reflects light emitted by the LED chip 12. It is preferable that in order to efficiently take out the light emitted by the LED chip 12, the reflecting surface be made of a metal film containing silver or aluminum.

The lead frame 13 is insert-molded in the frame body 11. The lead frame 13 has a top end formed in a divided manner, with a part thereof exposed on the bottom surface of the depressed portion 11a of the frame body 11. Further, the lead frame 13 has a bottom end forming an external terminal by being cut into a predetermined length and bent along the outside wall of the frame body 11.

The LED chip 12 (LED element) is for example a GaN semiconductor light-emitting element having a conductive substrate, and has a bottom electrode formed on the bottom surface of the conductive substrate and has a top electrode formed on the other surface. Light (primary light) emitted by the LED chip 12 is a blue light that falls within the range of 430 to 480 nm and has its peak wavelength at 450 nm. Further, the LED chip 12 is die-bonded with conductive brazing filler metal to one side of the top end of the lead frame 13 that is exposed on the bottom surface of the depressed portion 11a. Furthermore, the LED chip 12 has its top electrode wire-bonded to the other side of the top end of the lead frame 13 via the wire 14. In this way, the LED chip 12 is electrically connected to the lead frame 13.

The resin 15 seals in the depressed portion 11a by being charged into the depressed portion 11a. Further, the resin 15 is preferably silicone resin, as it is required to be highly durable against the short-wavelength primary light.

The phosphors 16 and 17 are scattered across the resin 15. The phosphor 16 is a green phosphor that emits a green secondary light (having a peak wavelength of 500 nm or longer to 550 nm or shorter) that is longer in wavelength than the primary light, and is for example made of a Eu-activated β sialon phosphor material. Meanwhile, the phosphor 17 is a red phosphor that emits a red secondary light (having a peak wavelength of 600 nm or longer to 780 nm or shorter) that is longer in wavelength than the primary light, and is for example made of a phosphor material obtained by combining CaAlSiN3:Eu. The use of such phosphors 16 and 17 makes it possible to obtain a three band LED 10 with good color rendering properties.

In the LED 10 thus configured, as the primary light emitted from the LED chip 12 passes through the resin 15, a portion of the primary light excites the phosphors 16 and 17 to be converted into a secondary light. The emitted light (combined light) obtained by mixing the primary light and the secondary light is radiated outward substantially in the form of a white light.

FIG. 5 is a graph showing the emission spectrum of the LED 10. The vertical axis represents intensity (a.u.), and the horizontal axis represents wavelength (nm).

As shown in FIG. 5, the emission spectrum of the three band LED 10 is distributed in such a manner as to have peaks at blue, green, and red, with a blue light at the highest peak. Further, the LED 10 uses particular phosphors 16 and 17 that highly efficiently emits lights by being excited by a blue light having a wavelength in the range of 430 to 480 nm in the primary light. This makes it possible to obtain a light-emitting device 5 (LED 10) having its spectral characteristics adjusted in conformity to the transmission characteristics of the liquid crystal display apparatuses 1 and 2.

[LED Classification Device]

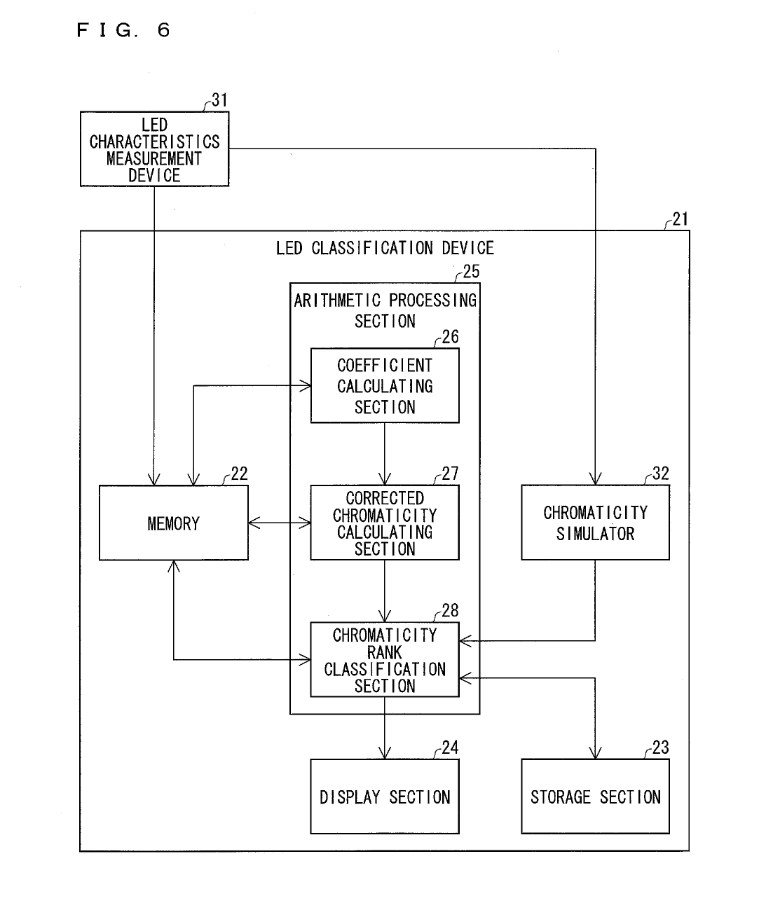

FIG. 6 is a block diagram showing a configuration of an LED classification device 21.

The LED classification device 21 shown in FIG. 6 is used to achieve an LED classification method of the present embodiment for classifying LEDs 10 that are used as the aforementioned light-emitting devices 5 into light-emitting devices 5 suitable for the backlight 3 or 8. In order to classify the LEDs 10, the LED classification device 21 includes a memory 22, a storage section 23, a display section 24, and an arithmetic processing section 25.

(Configuration of the Memory, the Storage Section, and the Display Section)

The memory 22 is a volatile memory in which to temporarily store characteristics measurement values obtained by an LED characteristics measuring device 31 measuring the characteristics of the LEDs 10 or in which to temporarily store arithmetic data generated through arithmetic processing by the arithmetic processing section 25. The characteristics measurement values are values which, for all of the LEDs 10 to be classified, are stored in the memory 22 in association with codes so assigned to the respective LEDs 10 that the LEDs 10 can be identified. The LED characteristics measuring device 31 is a device that measures the characteristics of the LEDs 10. The LED characteristics measuring device 31 measures the chromaticity, peak wavelength, etc. of each LED 10 with a large number of LEDs 10 emitting light and output the chromaticity, peak wavelength, etc. of each LED 10 as characteristics measurement values.

The storage section 23 is a storage device in which to save results of classification of the LEDs 10 as obtained through arithmetic processing by the arithmetic processing section 25, and is constituted by a hard disk device and the like.

The display section 24 is a display device for displaying the results of classification.

(Configuration of the Arithmetic Processing Section)

The arithmetic processing section 25 performs a process for classifying the LEDs 10 on the basis of the characteristics measurement values obtained from the LED characteristics measuring device 31. The arithmetic processing section 25 uses the following arithmetic expressions to correct the chromaticities (x,y) of light emitted by the LEDs 10 to be corrected chromaticities (x1,y1) based on the assumption that the light emitted by the LED 10 has traveled through the aforementioned color filter 7 (blue filter) (chromaticity correcting section). Further, the arithmetic processing section 25 classifies the LEDs 10 according to chromaticity rank on the basis of the corrected chromaticities (x1,y1). Alternatively, the arithmetic processing section 25 classifies the LEDs 10 according to chromaticity rank on the basis of the output chromaticities (xd,yd), calculated in advance through simulation, of light that is emitted from the liquid crystal panel 4 (display).

It should be noted that on the assumption that light emitted from a light-emitting device 5 has traveled through the color filter 7 (blue filter), a correction is made in consideration of a change in chromaticity that happens until the emitted light travels through the liquid crystal panel 4. This change in chromaticity is a change in transmitted light with respect to the chromaticity of the emitted light in a case where the light emitted from the light-emitting device 5 has traveled through optical members such as a diffuser, an optical sheet, and a light guide plate, the color filter 7 (blue filter), and the liquid crystal panel 4. This causes the correction to be a more preferable correction that is more suitable for an actual display on the liquid crystal panel 4.

Further, in the present embodiment, as described above, a correction to the transmission characteristics of the color filter 7 is a correction to the transmission characteristics of a blue filter. This is because, as mentioned above in section “Technical Problem”, the fact that a deviation of the peak wavelength of a blue light component in light emitted from a light-emitting device 5 is large at a mass-production level of the light-emitting device 5 significantly affects the difference between the chromaticity of the emitted light before the transmission of the emitted light through the color filter 7 and the chromaticity of the emitted light after the transmission of the emitted light through the color filter 7. Regarding this, correcting the transmission characteristics of the red and the green filters achieves a correction that is more suitable for an actual display on the liquid crystal panel. However, a method for correcting only the transmission characteristics of the blue filter can be said to be a simple method for correcting measured data on the light-emitting device 5 with simple correction formulas such as those mentioned below. Further, since this correction method can eliminate the need for rank classification regarding blue light peaks, it can reduce the number of characteristics classification items (control characteristics items) of the light-emitting device 5.

x1=x−α×(λp−λ0)

y1=y−β×(λp−λ0)

In the foregoing arithmetic expressions, λp is the measured value of the peak wavelength of a blue light component in light emitted by an LED 10. The effect of a blue light on the chromaticity is exerted not only on the peak wavelength but also on the spectral shape. Therefore, this measured value is not a maximum point of emission intensity but a measured value of a dominant wavelength with the emission spectral shape taken into account. Measurement of the dominant wavelength is performed by measuring the dominant wavelength as a blue monochromatic light by, for example, extracting an emission spectrum of 480 nm or shorter. This measurement takes into account the effect of absorption of the blue LED light inside the light-emitting device 5 into the phosphors.

λ0 is the center value (reference wavelength) of measured values of this peak wavelength, and is set in the range of 445 nm to 450 nm and is preferably approximately 448 nm. The reference wavelength λ0 is for example a particular wavelength determined according to a user's demand. The LEDs 10 are manufactured so that the peak wavelength λp is equal to the reference wavelength λ0. In actuality, however, the peak wavelength λp varies in the range of 442 nm to 452 nm.

α and β are coefficients (wavelength correction coefficient of chromaticity), and are set in the range of 0 to 0.01.

The chromaticities (x,y) and the peak wavelength λp are obtained as characteristic measurement values of an LED 10 from the LED characteristics measuring device 31.

In order to achieve the foregoing process, the arithmetic processing section 25 has a coefficient calculating section 26 (chromaticity predicting section), a corrected chromaticity calculating section 27 (chromaticity predicting section), and a chromaticity rank classification section 28.

<Configuration of the Coefficient Calculating Section>

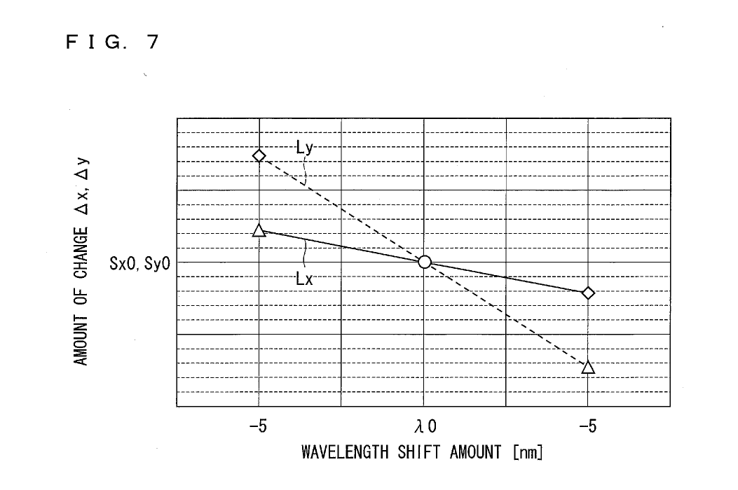

The coefficient calculating section 26 (coefficient calculating section) calculates the coefficients of α and β of the arithmetic expressions on the basis of the chromaticities (x,y) and the peak wavelength λp as characteristics measurement values from the LED characteristics measuring device 31 as stored in the memory 22. Specifically, the coefficient calculating section 26 performs the following process. FIG. 7 is a diagram for explaining the process, and is a graph showing amounts of change in chromaticity after the transmission of a blue light through a color filter with respect to amounts of shift in peak wavelength from the reference wavelength of peak wavelengths of blue lights from the LEDs 10 that are to be classified.

As shown in FIG. 7, the coefficient calculating section 26 obtains, as the coefficients α and β, the inclinations of straight lines Lx and Ly connecting two points respectively specified by the peak wavelengths λp of two difference LEDs 10 and the two amounts of change Δx and Δy corresponding to these peak wavelengths λp, and stores the coefficients α and β in the memory 22. Use of such coefficients α and β makes it possible to straight-line approximately obtain the amounts of change Δx and Δy with respect to amounts of shift in given peak wavelength λp from the reference wavelength λ0 by using the straight lines Lx and Ly.

<Configuration of the Corrected Chromaticity Calculating Section>

The corrected chromaticity calculating section 27 (corrected chromaticity calculating section) applies the coefficients α and β stored in the memory 22 to the arithmetic expressions to compute the corrected chromaticities (x1,y1) according to the arithmetic expressions with respect to the peak wavelengths λp concerning all of the LEDs 10 as read out from the memory 22. The corrected chromaticity calculating section 27 stores, in the memory 22, the corrected chromaticities (x1,y1) thus calculated.

In each of the arithmetic expressions, (λp−λ0) is the difference (wavelength shift amount) between the peak wavelength λp and the reference wavelength λ0, and as shown in FIG. 7, the amounts of change Δx and Δy in chromaticity with respect to this wavelength shift amount is straight-line approximately obtained. By multiplying the wavelength shift amount by each of the coefficients α and β, correction values for the chromaticities (x,y) are obtained. Moreover, by subtracting the correction values from the chromaticities (x,y) read out from the memory 22, the corrected chromaticities (x1,y1) are obtained.

<Configuration of the Chromaticity Rank Classification Section>

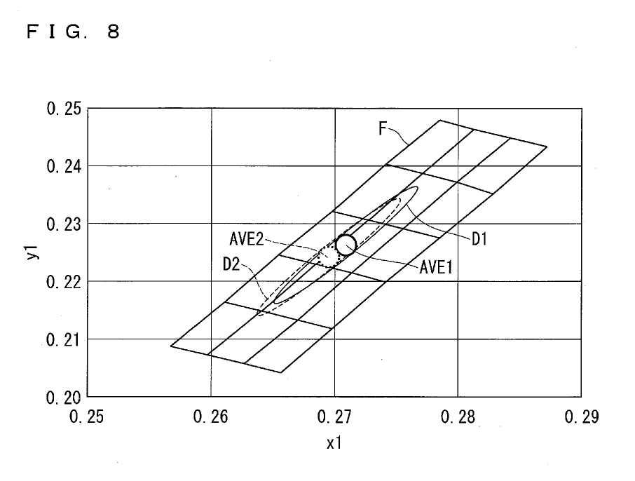

The chromaticity rank classification section 28 (chromaticity rank classification section) reads out the corrected chromaticities (x1,y1) from the memory 22 and classifies the LEDs 10 according to chromaticity rank on the basis of the chromaticities (x1,y1). FIG. 8 is a diagram showing an example of such chromaticity rank classification. As shown in FIG. 8, the chromaticity rank classification section 28 classifies the LEDs 10 according to whether or not the corrected chromaticities (x1,y1) are distributed within a rectangular frame F serving as a predetermined range, and stores the result in the storage section 23 in association with the codes of the LEDs 10. Further, the chromaticity rank classification section 28 causes the result of classification of the LEDs 10 as stored in the memory 22 to be displayed on the display section 24 together with the codes as the LEDs 10 that are to be selected.

The frame F is divided into smaller ranges configured such that demarcations can be made according to rank for each division. In this frame F, the corrected chromaticities (x1,y1) of the group of LEDs 10 the wavelengths of whose blue lights are short are distributed in a range D1 indicated by a solid line. In the range D1, the peak wavelength is 444.7 nm, and the average AVE1 of chromaticity is in a position indicated by a solid circle. Meanwhile, in the frame F, the chromaticities of the group of LEDs 10 the wavelength of whose blue lights are long are distributed in a range D2 indicated by a broken line. In the range D2, the peak wavelength is 446.2 nm, and the average AVE2 of chromaticity is in a position indicated by a broken circle.

<Configuration of a Chromaticity Simulator>

The chromaticity rank classification section 28 may use a chromaticity simulator 32 to classify the LEDs 10 according to chromaticity rank on the basis of a predicted value (simulated value) obtained by predicting (simulating) the chromaticity of light transmitted by the liquid crystal panel 4. This makes it unnecessary to calculate the coefficients α and β and the corrected chromaticities (x1,y1).

The simulated value is obtained by the chromaticity simulator 32 (chromaticity predicting section) shown in FIG. 6 on the basis of several peak wavelengths λp (dominant wavelengths) that are predicted in advance, and is prepared in the form of a table of association with the peak wavelengths λp. With this, the chromaticity rank classification section 28 classifies the LEDs 10 according to chromaticity rank on the basis of a simulated value read out from the table on the basis of a peak wavelength λp actually measured. The chromaticity simulator 32 is included in the LED classification device 21.

The chromaticity simulator 32 calculates the output chromaticities (xd,yd) on the display of spectrum data (particular measured value) measured by the LED characteristics measurement device 31. This calculation is performed by simulation taking into account the transmission properties of the optical members, such as the diffuser, the optical sheet, and the light guide plate, and the color filter 7 (blue filter).

It should be noted here that the aforementioned corrected chromaticities (x1,y1) are totally different values from the output chromaticities (xd,yd). The following explains a reason for this.

The corrected chromaticities (x1,y1) are chromaticities corrected for classification of the LEDs 10 according to chromaticity rank, and reflects only the change amounts of change Δx and Δy caused by a difference in wavelength among the LEDs 10. On the other hand, the output chromaticities (xd,yd) are chromaticities on the display.

The corrected chromaticities (x1,y1) and the output chromaticities (xd,yd) are associated with each other as expressed by a formula below. The formula is an approximation formula as the corrected chromaticities (x1,y1) are linearly approximated.

$$xd \approx x 1 + Sx 0 = x - α \times ( λ p - λ0 ) + Sx 0$$

$$yd \approx y 1 + Sy 0 = y - α \times ( λ p - λ0 ) + Sy 0$$

where Sx0 is a constant expressed as a shift amount of chromaticity x (a difference between the chromaticity x on the display and the chromaticity x of each LED 10) when λp−λ0, the shift amount taking on a value in the range of approximately 2/100 to 3/100, and Sy0 is a constant expressed as a shift amount of chromaticity y (a difference between the chromaticity y on the display and the chromaticity y of each LED 10) when λp=λ0, the shift amount taking on a value in the range of approximately 5/100 to 6/100.

The form of provision of a simulated value is not limited to the example described above, and can be applied in various forms.

<Realization Form of the Arithmetic Processing Section>

The blocks of the arithmetic processing section 25, namely the coefficient calculating section 26, the corrected chromaticity calculating section 27, and the chromaticity rank classification section 28, are realized by software (LED classification program) as executed by a CPU as follows: This LED classification program causes a computer to function as the LED classification device 21 (the coefficient calculating section 26, the corrected chromaticity calculating section 27, and the chromaticity rank classification section 28).

Alternatively, each of the blocks described above may be constituted by hardware logic, or may be realized by processing by program with a DSP (digital signal processor).

Program code (executable program, intermediate code program, or source program) for the software may be stored in a computer-readable storage medium. The objective of the present invention can also be achieved by mounting the storage medium to the LED classification device 21 in order for the CPU to retrieve and execute the program code contained in the storage medium.

The storage medium may be, for example, a tape, such as a magnetic tape or a cassette tape; a magnetic disk, such as a floppy (Registered Trademark) disk or a hard disk, or a disk, including an optical disk such as CD-ROM/MO/MD/BD/DVD/CD-R; a card, such as an IC card (memory card) or an optical card; or a semiconductor memory, such as a mask ROM/EPROM/EEPROM (Registered Trademark)/flash ROM.

The LED classification device 21 may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, wired line, such as IEEE 1394, USB, electric power line, cable TV line, telephone line, or ADSL line; or wireless, such as infrared radiation (IrDA, remote control), Bluetooth (Registered Trademark), 802.11 wireless, HDR, mobile telephone network, satellite line, or terrestrial digital network. The present invention encompasses a carrier wave or data signal transmission in which the program code is embodied electronically.

(Process of LED Classification by the LED Classification Device)

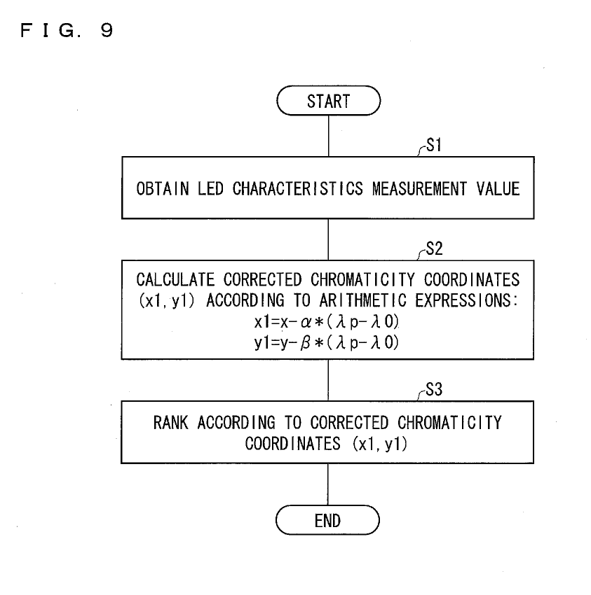

A process of classification of the LEDs 10 by the LED classification device 21 is described with reference to FIG. 9. FIG. 9 is a flow chart showing steps of the process of classification.

As shown in FIG. 9, first, the LED classification device 21 obtains the characteristics measurement values of all of the LEDs 10 to be classified from the LED characteristics measurement device 31 and stores the characteristics measurement values in the memory 22 (step 1). Further, by using the characteristics measurement values thus obtained, the LED classification device 21 calculates the coefficients α and β in advance on the basis of a simulation (coefficient calculating step, chromaticity correcting step). At this step, the coefficient calculating section 26 calculates, as the coefficients α and β, the inclinations of the straight lines Lx and Ly each connecting two points as mentioned above.

Next, by using the aforementioned arithmetic expressions and the coefficients α and β, the LED classification device 21 calculates the corrected chromaticities (x1,y1) (step 2: corrected chromaticity calculating step, chromaticity correcting step. At this step, for all of the LEDs 10 to be classified, the corrected chromaticity calculating section 27 calculates the corrected chromaticities (x1,y1) by using the measured chromaticities (x,y) and the peak wavelength λp for all of the LEDs 10 to be classified.

Then, the LED classification device 21 classifies the LEDs 10 according to chromaticity rank on the basis of the corrected chromaticities (x1,y1) (step 3: chromaticity rank classification step). At this step, the chromaticity rank classification section 28 classifies the LEDs 10 according to chromaticity rank in accordance with whether or not the corrected chromaticities (x1,y1) are distributed in the frame F shown in FIG. 8. If, as a result of this chromaticity rank classification, the corrected chromaticities (x1,y1) are in a predetermined range, those LEDs 10 which exhibit the corrected chromaticities (x1,y1) are classified as LEDs to be used in the backlights 3 and 8.

Further, in a case where the aforementioned output chromaticities (xd,yd) are used, the process is carried out according to the following procedure, albeit not illustrated.

First, in the same manner as in step S1, the LED classification device 21 obtains the characteristics measurement values of all of the LEDs 10 to be classified from the LED characteristics measurement device 31 and stores the characteristics measurement values in the memory 22. Further, the LED classification device 21 classifies the LEDs 10 according to chromaticity rank on the basis of the output chromaticities (xd,yd) calculated in advance through simulation by the chromaticity simulator 32.

[Effects of the LED Classification Device]

As described above, the LED classification device 21 is configured to use the arithmetic processing section 25 to correct, as the corrected chromaticities (x1,y1), the chromaticities (x,y) after transmission through the color filter 7 and classify the LEDs 10 according to chromaticity rank on the basis of the corrected chromaticities (x1,y1).

Thus, for those LEDs 10 whose peak wavelengths λp have deviated toward the longer side, the corrected chromaticities (x1,y1) are calculated so that the chromaticities (x,y) shifts toward blue (lower chromaticity) (c.f. the average AVE2 in FIG. 8). Meanwhile, for those LEDs 10 whose peak wavelengths λp have deviated toward the shorter side, the corrected chromaticities (x1,y1) are calculated so that the chromaticities (x,y) shift toward yellow (higher chromaticity) (c.f. the average AVE1 in FIG. 8).

Moreover, by using the corrected chromaticities (x1,y1) thus corrected, the LEDs 10 can be classified according to chromaticity rank on the basis of the prediction of a decrease (shift amount) in intensity of blue light by the color filter 7.

Alternatively, even with use of the aforementioned output chromaticities (xd,yd), the LEDs 10 can be similarly classified according to chromaticity rank.

By mounting, on the respective backlights 3 and 8 of the liquid crystal display apparatuses 1 and 2, the LEDs 10 selected according to such chromaticity rank classification, variations in luminance of blue light on the liquid crystal panel 4 can be suppressed. In particular, the light emitted by the LEDs 10 whose peak wavelengths λp are short have its blue light component cut by the color filter 7 when it travels through the liquid crystal panel 4 (color filter 7), so that the chromaticity shifts more toward the yellow side. Therefore, by making the chromaticity correction, chromaticity rank classification more suitable as a light source for use in a liquid crystal panel can be performed.

It should be noted that since the yield of LEDs 10 ranked in the center of the frame F shown in FIG. 8 is low, LEDs 10 whose chromaticity is distributed high and low are also used. This applies the publicly-known array rule that LEDs that greatly differ in chromaticity are arranged adjacent to each other so that the chromaticity of the liquid crystal panel 4 as a whole averages out.

[Addition]

Since the LEDs 10 contain the phosphors 16 and 17, the emission spectrum also contains the color components of the phosphors. This allows the LED characteristics measurement device 31 to obtain a wavelength of blue light by measuring a peak wavelength. However, the measurement of a peak wavelength is easily noised and is therefore susceptible to error. To diminish the effect of noise, it is only necessary for the LED characteristics measurement device 31 to designate a range of wavelengths from 400 nm to a longer wavelength where the color components of the phosphors do not appear, and to calculate a dominant wavelength in this range of wavelengths. As mentioned earlier, for example, a dominant wavelength as blue monochromatic light is measured by extracting an emission spectrum of 480 nm or shorter. This measurement takes into account the effect of absorption of the blue LED light inside the light-emitting device 5 into the phosphors.

The present embodiment has been described regarding the classification of LEDs 10 each containing a green phosphor and a red phosphor. However, LEDs 10 may each contain any other phosphor. For example, the LEDs 10 may each contain, instead of a green phosphor and a red phosphor, a yellow phosphor that is excited by the blue light of a blue LED. With this, the mixture of the blue light of the blue LED and the yellow light of the yellow phosphor gives a false color of white.

Further, in the present embodiment, the LED characteristics measurement device 31 is provided outside of the LED classification device 21. However, the LED characteristics measurement device 31 is provided as part of the LED classification device 21.

### Embodiment 2

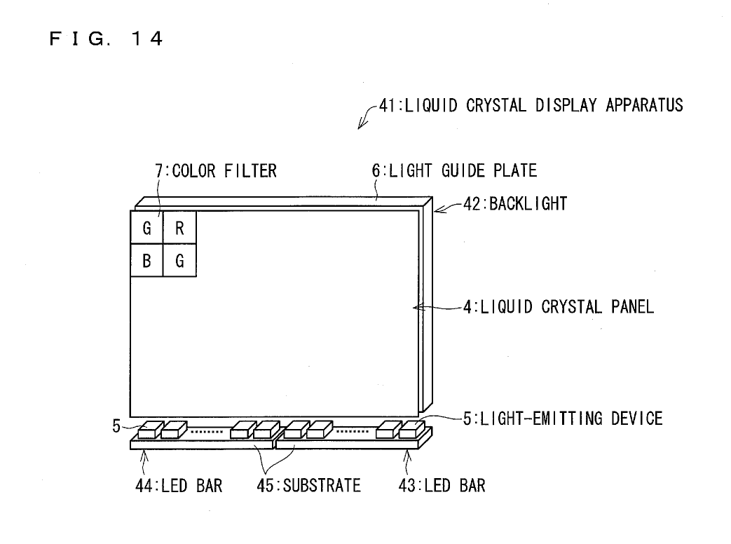

Another embodiment of the present invention is described below with reference to FIGS. 14 through 19.

In the present embodiment, components having the same functions as those of Embodiment 1 are given the same reference signs, and as such, are not described.

[Liquid Crystal Display Apparatus]

(Configuration of a Liquid Crystal Display Apparatus)

FIG. 14 is a perspective view schematically showing a configuration of a liquid crystal display apparatus 41 according to the present embodiment.

As shown in FIG. 14, the liquid crystal display apparatus 41 includes a backlight 42 and a liquid crystal panel 4.

The backlight 42 is placed at the back of the liquid crystal panel 4. The backlight 42 is an edge-light-type backlight that illuminates the whole surface of the liquid crystal panel 4. The backlight 42 includes a light guide plate 6 and LED bars 43 and 44.

The LED bars 43 and 44 are linear light sources disposed adjacent to at lease one light-entrance-side edge of the light guide plate 6. In the example shown in FIG. 14, the LED bars 43 and 44 are disposed at a lower side. Further, the LED bars 43 and 44 are disposed on the right- and left-hand sides of a viewer squarely facing the liquid crystal display apparatus 41, respectively.

The LED bars 43 and 44 are each constituted by a plurality of light-emitting devices 5 and a substrate 45.

The substrate 45 is in the shape of a long narrow strip (in a linear fashion). The substrate 45 has a width that is slightly wider than an outside dimension (width) of each of the light-emitting device 5. The substrate 45 has a mounting surface on which the light-emitting devices 5 are mounted and on which printed wires (not illustrated) provided to feed electricity to the light-emitting device 5. Further, provided at both edges or one edge of the substrate 45 are positive and negative electrode terminals (not illustrated) that are connected to the printed wires. Connection of external feeding wires to these positive and negative electrode terminals allows the light-emitting devices 5 to be fed with electricity.

The light-emitting devices 5 are white LEDs mounted at regular intervals on the substrate 45 so as to emit light toward the light guide plate 6. As with the white LEDs used in the liquid crystal display apparatuses 1 and 2 of Embodiment 1, these white LEDs may be the aforementioned LEDs 10 classified according to chromaticity rank on the basis of the corrected chromaticities (x1,y1) obtained by the LED classification device 21.

For surface emission of linear beams of light coming from the LED bars 43 and 44, the light guide plate 6 is structured to be able to take out the light from every part of the light-emitting surface.

The liquid crystal display apparatus 41 may use three or more LED bars as light sources for the backlight 42 instead of using the two LED bars 43 and 44.

(Attenuation of a Blue Component of Light by the Light Guide Plate)

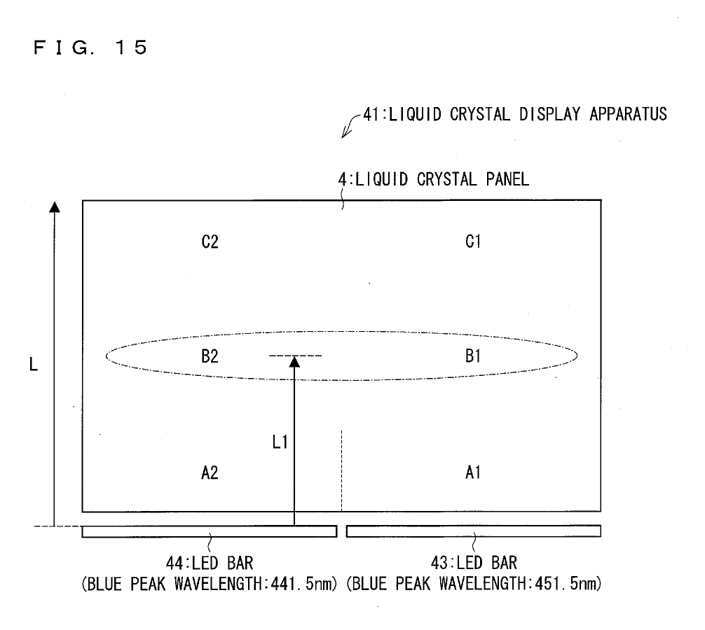

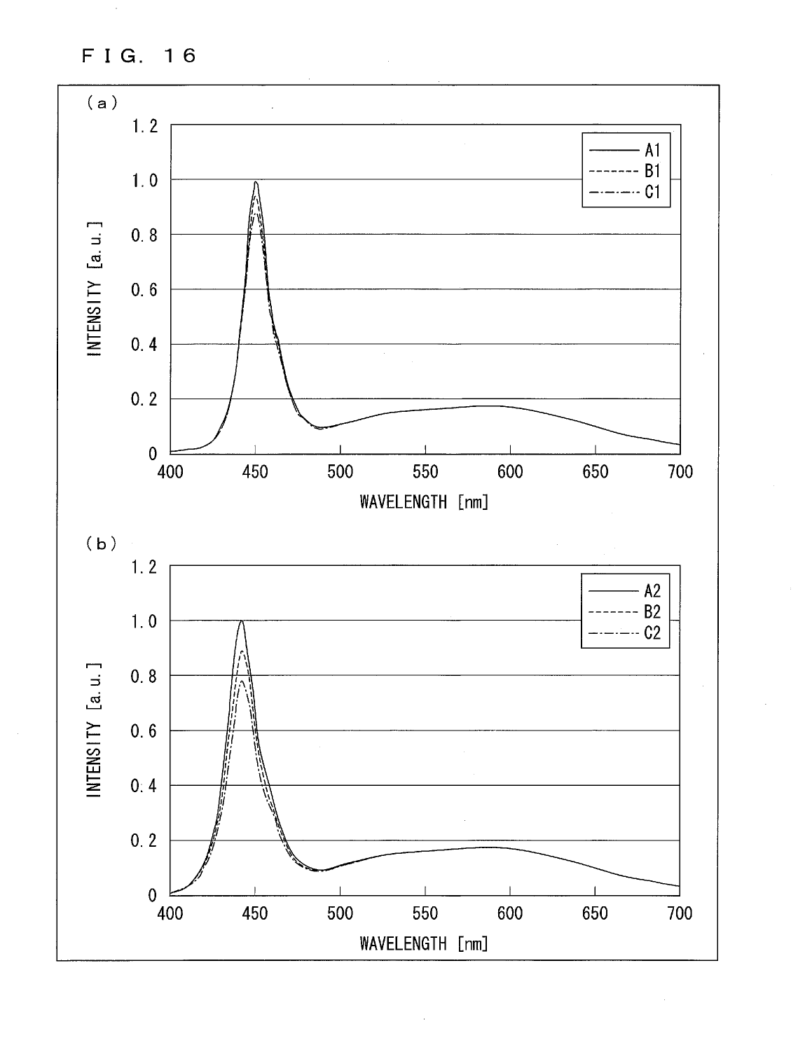

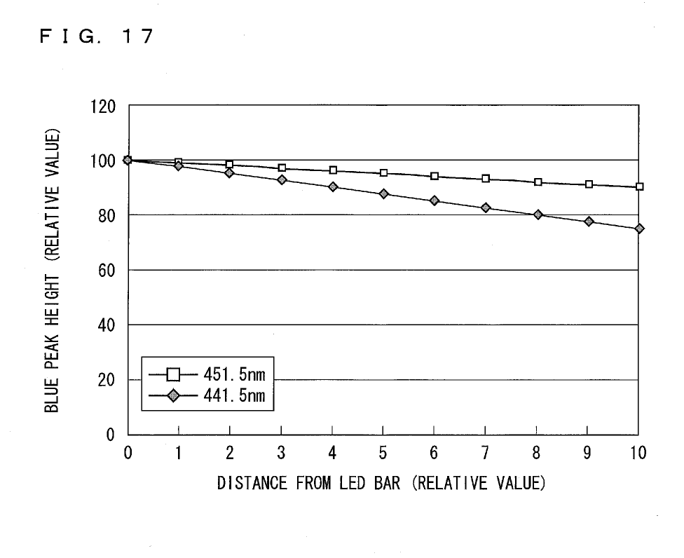

FIG. 15 is a diagram showing a distribution of a blue component, in different regions on the liquid crystal panel 4, of beams of light respectively emitted from the two LED bars 43 and 44. FIG. 16 is a set of graphs (a) and (b), (a) being a graph showing an emission spectrum of light from the LED bar 43 according to the distribution of a blue component shown in FIG. 15, (b) being a graph showing an emission spectrum of the LED bar 44 according to the distribution of a blue component shown in FIG. 15. FIG. 17 is a graph showing a relationship between the distance from each of the two LED bars 43 and 44 and the peak height of the blue component of light from each of these LED bars 43 and 44.

A common light guide, such as the light guide plate 6, has the transmission properties to absorb more of the blue component of light with an increasing distance from the light source. For this reason, light emitted from the LED bars 43 and 44 and traveling through the light guide plate 6 has its blue component gradually attenuated.

Let it be assumed here, as shown in FIG. 15, that the wavelength (blue peak wavelength) at which the intensity of the blue component of light emitted by the LED bar 43 reaches its peak is 451.5 nm and the wavelength at which the intensity of the blue component of light emitted by the LED bar 44 reaches its peak is 441.5 nm.

A peak value (blue peak) of the intensity of the blue component of light emitted by the LED bar 43 gets attenuated as the light passes from a region A1 close to the LED bar 43 through a region B1 in the central part of the liquid crystal panel 4 (display surface) to a region C1 distant from the LED bar 43 (a region near a side opposite to the LED bar 43). As shown in (a) of FIG. 16, the blue peak is highest in the region A1, slightly lower in the region B1, and lowest in the region C1.

Meanwhile, a blue peak of the intensity of the blue component of light emitted by the LED bar 44 gets attenuated as the light passes from a region A2 close to the LED bar 44 through a region B2 in the central part of the liquid crystal panel 4 to a region C2 distant from the LED bar 44 (a region near a side opposite to the LED bar 44). As shown in (b) of FIG. 16, the blue peak is highest in the region A2, slightly lower in the region B2, and lowest in the region C2.

In this way, the amount of attenuation of light emitted by the LED bars 43 and 44 varies according to the distance L from the LED bars 43 and 44.

It should be noted that the central part of the liquid crystal panel 4 corresponds to a region falling within a predetermined range including the center of a space between the light-entrance-side edge of the light guide plate 6 (edge at which the LED bars 43 and 44 are disposed) and an edge of the light guide plate 6 opposite to the light-entrance-side edge.

As shown in FIG. 17, the heights of blue peaks of light emitted from the LED bar 43 (at a blue peak wavelength of 451.5 nm) and light emitted from the LED bar 44 (at a blue peak wavelength of 441.5 nm) vary in amount of attenuation according to the distance from the LED bars 43 and 44. In FIG. 17, the horizontal axis represents the relative distance from each of the LED bars 43 and 44. The number “0” on the horizontal axis represents the closest position to the LED bars 43 and 44, and the number “10” on the horizontal axis represents the most distant position from the LED bars 43 and 44. Further, the vertical axis represents the relative height of each blue peak. The number “0” on the vertical axis represents the smallest value, and the number “100” on the vertical axis represents the largest value.

As shown in FIG. 17, the heights of blue peaks of lights from the LED bars 43 and 44 both take on the largest values at a distance of “0” from the LED bars 43 and 44 (hereinafter simply referred to as “distance”). However, whereas the height of the blue peak of light from the LED bar 43 decreases to approximately “90” at a distance of “10”, the height of the blue peak of light from the LED bar 44 decreases to “80” or smaller at a distance of “10”

In this way, the shorter the blue peak wavelength is, the more attenuated the height of a blue peak becomes.

[Chromaticity Adjustment]

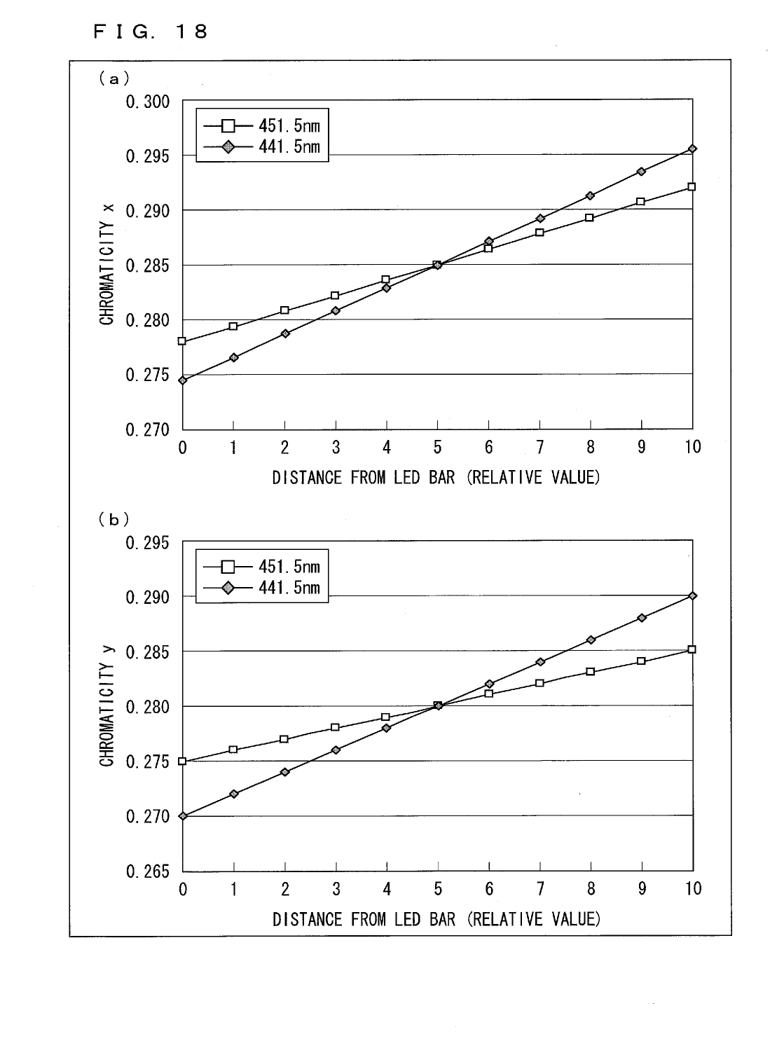

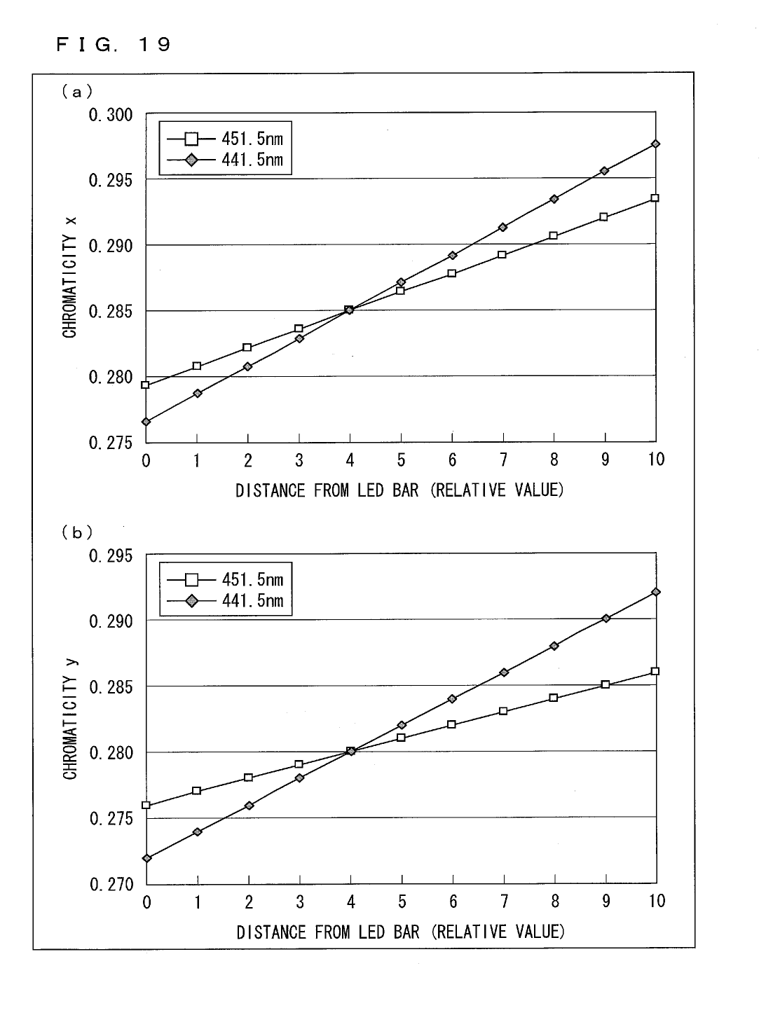

FIG. 18 is a set of graphs (a) and (b) showing relationships between the distance from each of the two LED bars 43 and 44 and the chromaticities x and y of two beams of light from the two LED bars 43 and 44, respectively, the two LED bars 43 and 44 using LEDs 10 so chromaticity-corrected that there is no difference in chromaticity between the two beams of light in the central part (regions B1 and B2) of the liquid crystal panel 4. FIG. 19 is a set of graphs (a) and (b) showing relationships between the distance from each of the two LED bars 43 and 44 and the chromaticities x and y of two beams of light from the two LED bars 43 and 44, respectively, the two LED bars 43 and 44 using LEDs 10 so chromaticity-corrected that there is no difference in chromaticity between the two beams of light in regions (regions A1 and A2) on the liquid crystal panel 4 near the two LED bars 43 and 44.

In each of FIGS. 18 and 19, as in FIG. 17, the horizontal axis represents the relative distance from each of the LED bars 43 and 44. The number “0” on the horizontal axis represents the closest position to the LED bars 43 and 44, and the number “10” on the horizontal axis represents the most distant position from the LED bars 43 and 44. Further, in the following description, the distance from each of the LED bars 43 and 44 as represented by the horizontal axis is simply referred to as “distance”.

Normally, the line of sight of a person looking at the liquid crystal display apparatus 41 is usually concentrated on the central part of the screen. Therefore, it is preferable that as indicated by an alternate long and short dash line in FIG. 15, there be no difference in chromaticity of light appearing in the central part of the liquid crystal panel 4. For this reason, as the LEDs 10 to be mounted on the LED bars 43 and 44, LEDs 10 are used which have been so subjected to chromaticity correction and chromaticity rank classification according to Embodiment 1 that there is no difference in chromaticity between the two beams of light radiated from the respective regions B1 and B2.

With this, as shown in (a) and (b) of FIG. 18, the chromaticities x and y of lights appearing in the positions at the distance “5”, which corresponds to the center of the regions B1 and B2, match.

However, the mounting, on the LED bars 43 and 44, of the LEDs 10 thus subjected to chromaticity correction and chromaticity rank classification causes the following inconvenience.

In the regions A1 and A2 (in the range of distances “0” to “4”), which is close to the LED bars 43 and 44, as shown in (a) and (b) of FIG. 18, there is a large difference between the chromaticities x and y of respective lights emitted from the LED bars 43 and 44. In particular, at the distance “0”, the difference in chromaticity of light is largest. This is because in the regions A1 and A2, the chromaticity is higher at a longer blue peak wavelength and lower at a shorter blue peak wavelength.

For this reason, as shown in FIG. 15, there is a difference in chromaticity between lights respectively appearing in the regions A1 and A2, so that a boundary of chromaticity appears at a boundary division between the regions A1 and A2. This phenomenon is observed when the difference in blue peak wavelength between the LED bars 43 and 44 is 7.5 nm or larger.

It should be noted here that the blue peak wavelength of each of the LED bars 43 and 44 is the average of the blue peak wavelengths of all of the light-emitting devices 5 (LEDs 10) mounted on that LED bar 43 or 44.

Such an inconvenience can be avoided as follows: If the chromaticities x and y of lights respectively appearing in the regions A1 and B1, rather than in the regions B1 and B2, match, the difference in chromaticity at the boundary division between the regions A1 and A2 can be alleviated. More preferably, it is only necessary, as shown in (a) and (b) of FIG. 19, that the chromaticities x and y of lights appearing in positions closer to the LED bars 43 and 44 than the regions B1 and B2 (e.g. positions on the regions A1 and A2 at the distance “4”) match.

This makes it possible to make inconspicuous the difference in chromaticity at the boundary division between the regions A1 and A2.

Further, it is preferable that the position in which the chromaticities match as described above be set as follows. Specifically, as shown in FIG. 15, the position is at a distance, from the light-entrance-side edge of the light guide plate 6, of 40% or more to less than 50% of the distance L1 between the edge and the central part (more specifically, the center of the regions B1 and B2) of the light guide plate 6. This makes it possible to almost completely eliminate the difference in chromaticity at the boundary division between the regions A1 and A2.

Further, restrictions on wavelength differences can be alleviated such that the boundary of chromaticity with a difference of 7.5 nm or larger in blue peak wavelength between the LED bars 43 and 44 is no longer visible and a boundary of chromaticity with a difference of 10 nm or less is also not visible. This makes possible a combination of the LED bar 43, which has a blue peak wavelength of 451.5 nm, and the LED bar 44, which has a blue peak wavelength of 441.5 nm.

Furthermore, as will be explained next, it is also possible to make inconspicuous the difference in chromaticity at the boundary division between the regions B1 and B2.

When the position in which the chromaticities of lights emitted from the respective LED bars 43 and 44 and outputted from the liquid crystal panel 4 match is shifted from the central part of the liquid crystal panel 4 toward the LED bars 43 and 44 as described above, the respective chromaticities of the lights are displaced, so that there occurs a difference in chromaticity. However, if the difference in chromaticity is 3/1000 or less for each of the chromaticities x and y, a boundary of chromaticity due to the difference in chromaticity will be hardly recognized by a human. On the other hand, if the difference in chromaticity is larger 3/1000 for each of the chromaticities x and y, a boundary of chromaticity due to the difference in chromaticity will be easily recognized by a human.

Further, when the position in which the chromaticities match is shifted toward the LED bars 43 and 44 as described above, there will be a large difference in chromaticity between the regions C1 and C2, which are distant from the LED bars 43 and 44. However, in the regions C1 and C2, the lights from the LED bars 43 and 44 mix with each other (color mixture) as they travel and spread through the light guide plate 6. For this reason, no boundary of chromaticity is seen at the boundary division between the regions C1 and C2, so that color unevenness between the regions C1 and C2 is inconspicuous.

The larger the liquid crystal display apparatus 41 is in screen size, the more of the same types of LED bars as the LED bars 43 and 44 need to be provided. Therefore, an improvement in image quality along with an increase in screen size can be effectively made by thus making inconspicuous a boundary of chromaticity of transmitted light in a region near an LED bar.

(Chromaticity Correction)

In order for the position in which the chromaticities match to be shifted toward the LED bars 43 and 44 as described above, the coefficients α and β that the aforementioned coefficient calculating section 26 uses to obtain corrected chromaticities (x1,y1) are set to be values that are smaller than the values at which the chromaticities match in the central part. For example, the coefficient calculating section 26 causes the coefficients αm and βm, at which the chromaticities match in the central part, to be changed as below to the coefficients αn and βn, with a shift in the position in which the chromaticities match:

αn=αm×0.75

βn=βm×0.75

As a result of the computations by the corrected chromaticity calculating section 27 using these coefficients αn and βn, the obtained corrected chromaticities (x1,y1) are slightly larger than the values at which at which the chromaticities match in the central part. This makes it possible to, as shown in (a) and (b) of FIG. 19, match the chromaticities x and y of the two beams of light radiated from the position at the distance “4”, which is closer to the LED bars 43 and 44 than the position (central part) at the distance “5”.

[Addition]

In the present embodiment, the LED bars 43 and 44 are disposed at the lower side of the light guide plate 6. However, this does not imply any limitation. Alternatively, the LED bars 43 and 44 may be disposed at either the right or left side of the liquid crystal panel 4 or the upper side of the light guide plate 6. Alternatively, such LED bars may be disposed on two opposite sides of the light guide plate 6. This configuration makes it possible to make inconspicuous a boundary of chromaticity near the LED bar at either side. Therefore, this configuration is more preferably than the configuration in which such LED bars are provided at one side of the light guide plate 6.

Further, the liquid crystal display apparatus 41 yields satisfactory results especially under the following conditions:

Size of LED 10: 4 to 8 mm×1 to 4 mm

Pitch between LEDs 10 on LED bars 43 and 44: 0.5 to 2.0 cm

Length of LED bars 43 and 44: 30 to 100 cm (with respect to the screen sizes of 31 to 100 of the liquid crystal display apparatus 41)

It should be noted, as a matter of course, that the present invention is not limited to the foregoing conditions.

[Summary]

A method for classifying LEDs according to one aspect of the present invention is a method for classifying LEDs, the LEDs (LEDs 10) each including a combination of an LED element (LED chip 12) that emits a primary light and a phosphor (LED chip 16, 17) that, upon excitation by the primary light, emits a secondary light having a longer wavelength than the primary light, the LEDs each emitting a combined light of the primary light and the secondary light, those ones of the LEDs whose primary lights have their chromaticities falling within a predetermined chromaticity range being classified as LEDs for use in a backlight (backlight 3, 8, 42) of a liquid crystal display apparatus (liquid crystal display apparatus 1, 2, 41), the method including: a chromaticity predicting step (coefficient calculating section 26, corrected chromaticity calculating section 27, or chromaticity simulator 32) of predicting, for all of the LEDs to be classified, the chromaticities of the primary lights having traveled through a color filter in a liquid crystal panel provided in the liquid crystal display apparatus; and a chromaticity rank classification step (chromaticity rank classification section 28) of classifying the LEDs according to chromaticity rank on a basis of the predicted chromaticities.

Further, an LED classification device (LED classification device 21) according to one aspect of the present invention is an LED classification device for classifying LEDs, the LEDs (LEDs 10) each including a combination of an LED element (LED chip 12) that emits a primary light and a phosphor (LED chip 16, 17) that, upon excitation by the primary light, emits a secondary light having a longer wavelength than the primary light, the LEDs each emitting a combined light of the primary light and the secondary light, those ones of the LEDs whose primary lights having their chromaticities falling within a predetermined chromaticity range being classified as LEDs for use in a backlight (backlight 3, 8, 42) of a liquid crystal display apparatus (liquid crystal display apparatus 1, 2, 41), the LED classification device including: a chromaticity predicting section (coefficient calculating section 26, corrected chromaticity calculating section 27, or chromaticity simulator 32) for predicting, for all of the LEDs to be classified, the chromaticities of the primary lights having traveled through a color filter in a color filter provided the liquid crystal display apparatus; and a chromaticity rank classification section (chromaticity rank classification section 28) for classifying the LEDs according to chromaticity rank on a basis of the predicted chromaticities.

In the configuration described above, the chromaticities based on the assumption of the primary lights having traveled through the color filter are predicted in the chromaticity predicting step or by the chromaticity predicting section. Then, the LEDs are classified according to chromaticity rank based on the predicted chromaticities in the chromaticity rank classification step or by the chromaticity rank classification section.

Such classification according to chromaticity rank with use of predicted chromaticities makes it possible to more appropriately classify the LEDs according to chromaticity rank on the basis of the prediction of a change in intensity of light by the color filter. Mounting in the respective backlights of liquid crystal display apparatuses of LEDs selected on the basis of such classification according to chromaticity rank makes it possible to suppress variation in luminance of light having traveled through the color filter from the backlight.

In the method for classifying LEDs, it is preferable that: the chromaticity predicting step include a chromaticity correcting step of calculating, for all of the LEDs to be classified, correction values for the chromaticities as based on transmission of the primary lights through the color filter, and of correcting the chromaticities as corrected chromaticities on a basis of the correction values for all of the LEDs to be classified; and the chromaticity correcting step include: a coefficient calculating step (coefficient calculating section 26) of calculating a reference chromaticity as of a time when a primary light having a predetermined reference wavelength has traveled through the color filter and amounts of change in the chromaticities with respect to the reference chromaticity, and of calculating, as coefficients of the correction values for the chromaticities, inclinations of the amounts of change with respect to a shift amount of each of the peak wavelengths of the primary lights from the reference wavelength, respectively; and a corrected chromaticity calculating step (corrected chromaticity calculating section 27) of calculating the correction values by multiplying a difference between the peak wavelength and the reference wavelength by the coefficients, respectively, and of calculating the corrected chromaticities by subtracting the correction values from the chromaticities obtained for all of the LEDs to be classified, respectively.

In the LED classification device, it is preferable that: the chromaticity predicting section include a chromaticity correcting section for calculating, for all of the LEDs to be classified, correction values for the chromaticities as based on transmission of the primary lights through the color filter, and for correcting the chromaticities as corrected chromaticities on a basis of the correction values for all of the LEDs to be classified; and the chromaticity correcting section include: a coefficient calculating section (coefficient calculating section 26) for calculating a reference chromaticity as of a time when a primary light having a predetermined reference wavelength has traveled through the color filter and amounts of change in the chromaticities with respect to the reference chromaticity, and for calculating, as coefficients of the correction values for the chromaticities, inclinations of the amounts of change with respect to a shift amount of each of the peak wavelengths of the primary lights from the reference wavelength, respectively; and a corrected chromaticity calculating section (corrected chromaticity calculating section 27) for calculating the correction values by multiplying a difference between the peak wavelength and the reference wavelength by the coefficients, respectively, and for calculating the corrected chromaticities by subtracting the correction values from the chromaticities obtained for all of the LEDs to be classified, respectively.

In the configuration described above, the corrected values for the chromaticities based on the assumption of the primary lights having traveled through the color filter are calculated in the chromaticity correcting step or by the chromaticity correcting section for all of the LEDs to be classified, and on the basis of these corrected values, the chromaticities obtained for all of the LEDs to be classified are corrected as corrected chromaticities. Further, since the coefficients of the correction values are calculated in the coefficient calculating step or by the coefficient calculating section on the basis of the inclinations of the amounts of change in chromaticity with respect to the reference chromaticity obtained on the basis of the assumption that the primary light has traveled through the color filter, a change in chromaticity due to the transmission of the primary light through the color filter is reflected in the correction values. Moreover, in the corrected chromaticity calculating step or by the corrected chromaticity calculating section, the corrected chromaticities are calculated by subtracting, from the chromaticities, the correction values thus obtained.

This makes it possible to easily cause a change in chromaticity due to the color filter to be reflected in a correction of chromaticity.

The method for classifying LEDs is preferably configured such that with respect to the liquid crystal display apparatus in which the backlight includes a plurality of linear light sources (LED bar 43, 44) having a plurality of the LEDs and provided adjacent to each other and a light guide plate having at least one edge side on which emitted lights from the linear light sources are incident and planarly radiating the emitted lights onto the liquid crystal panel, the coefficient calculating step includes calculating the coefficients so that the chromaticities of transmitted lights obtained as a result of the emitted lights from the respective linear light sources having traveled through the light guide plate and then through the liquid crystal panel match in a position closer to a light entrance side of the light guide plate than a central part between an edge of the light guide plate on the light entrance side and an edge of the light guide plate opposite to the light-entrance-side edge.

Further, the LED classification device is preferable configured such that with respect to the liquid crystal display apparatus in which the backlight includes a plurality of linear light sources having a plurality of the LEDs and provided adjacent to each other and a light guide plate having at least one edge side on which emitted lights from the linear light sources are incident and planarly radiating the emitted lights onto the liquid crystal panel, the coefficient calculating step includes calculating the coefficients so that the chromaticities of transmitted lights obtained as a result of the emitted lights from the respective linear light sources having traveled through the light guide plate and then through the liquid crystal panel match in a position closer to a light entrance side of the light guide plate than a central part between an edge of the light guide plate on the light entrance side and an edge of the light guide plate opposite to the light-entrance-side edge.

In the configuration described above, the LEDs are classified according to chromaticity rank based on the corrected chromaticity calculated with use of the coefficients thus calculated. When these LEDs are used to fabricate the linear light sources, the chromaticities of transmitted lights obtained as a result of the emitted lights from the respective linear light sources having traveled through the light guide plate and then through the liquid crystal panel match in a position closer to the light entrance side than the central part. This makes it possible to, as mentioned above, make inconspicuous a boundary of chromaticity in a region close to the linear light sources.

Further, the coefficient calculating step and the coefficient calculating section are preferably configured to calculate the coefficients so that a difference in chromaticity between the transmitted lights in the central part is 3/1000 or smaller.

In the configuration described above, with a difference in chromaticity of 3/1000 or smaller between transmitted lights in the central part, a boundary of chromaticity due to the difference in chromaticity is hardly recognized by a human. This makes it possible to make inconspicuous the boundary of chromaticity also in the central part.

The LED classification method or the LED classification device is preferably configured such that the primary lights are blue lights.

As for the blue lights, as mentioned earlier, due to variations in peak wavelength among the LEDs, the intensity of light having traveled though the color filter varies, with the result that display colors are affected. To this, as mentioned earlier, by correcting the chromaticity on the basis of the prediction of a change due to transmission through the color filter, the LEDs can be properly classified according to chromaticity rank on the basis of a change in chromaticity distribution by the color filter.

Further, an LED classification program according to one aspect of the present invention is a program for causing a computer to functions as each of the sections of the LED classification device. Further, a storage medium according to one aspect of the present invention is a computer-readable storage medium having the LED classification program stored therein. The LED classification program and the storage medium are encompassed in the technical scope of the present embodiment.

A liquid crystal display apparatus according to one aspect of the present invention is a liquid crystal display apparatus including: a liquid crystal panel; a plurality of linear light sources having a plurality of LEDs and provided adjacent to each other; a light guide plate having at least one edge side on which emitted lights from the linear light sources are incident and planarly radiating the emitted lights onto the liquid crystal panel, the LED being selected to be mounted on the linear light sources so that the chromaticities of transmitted lights obtained as a result of the emitted lights from the respective linear light sources having traveled through the light guide plate and then through the liquid crystal panel match in a position closer to a light entrance side of the light guide plate than a central part between an edge of the light guide plate on the light entrance side and an edge of the light guide plate opposite to the light-entrance-side edge.

In this configuration, when the liquid crystal display apparatus includes linear light sources using LEDs thus selected, the chromaticities of transmitted lights obtained as a result of the emitted lights from the respective linear light sources having traveled through the light guide plate and then through the liquid crystal panel match in a position closer to the light entrance side than the central part. This makes it possible to, as mentioned above, make inconspicuous a boundary of chromaticity in a region close to the linear light sources.

In the liquid crystal display apparatus described above, it is preferable that the position in which the chromaticities match be a position at a distance, from the light-entrance-side edge, of 40% or more to less than 50% of a distance between the light-entrance-side edge and the central part. This makes it possible to almost completely eliminate the difference in chromaticity in a region close to the linear light sources.

The present invention is not limited to the description of the embodiments above, but may be altered by a skilled person within the scope of the claims. An embodiment based on a proper combination of technical means disclosed in different embodiments is encompassed in the technical scope of the present invention. Furthermore, the technical means disclosed in different embodiments can be combined to form a new technical feature.

### INDUSTRIAL APPLICABILITY

An LED classification method according to the present invention is suitably applicable to a liquid crystal display apparatus using LEDs as a backlight, as the method corrects the chromaticities of LEDs on the basis of the prediction of a change in luminance of light having traveled through a color filter.

### REFERENCE SIGNS LIST

1 Liquid crystal display apparatus
2 Liquid crystal display apparatus
3 Backlight
4 Liquid crystal panel
5 Light-emitting device
7 Color filter
8 Backlight
10 LED
12 LED chip (LED element)
16 Phosphor
17 Phosphor
21 LED classifying device
22 Memory
23 Storage section
24 Display section
25 Arithmetic processing section
26 Coefficient calculating section (chromaticity predicting section, chromaticity correcting section, coefficient calculating section)
27 Corrected chromaticity calculating section (chromaticity predicting section, chromaticity correcting section, corrected chromaticity calculating section)
28 Chromaticity rank classification section (chromaticity rank classification section)
31 LED
32 Chromaticity simulator (chromaticity predicting section)
41 Liquid crystal display apparatus
42 Backlight
43 LED bar (linear light source)
44 LED bar (linear light source)
A1 Region
A2 Region
B1 Region
B2 Region
C1 Region
C2 Region
F Frame (predetermined range)
Sx0 Constant
Sy0 Constant
(x,y) Chromaticities
(x1,y1) Corrected chromaticities
Δx, Δy Amount of change
(xd,yd) Output chromaticity
α Coefficient
β Coefficient
αm Coefficient
βm Coefficient
αn Coefficient
βn Coefficient
λ0 Reference wavelength
λp Peak wavelength

1. (canceled)

2. A method for classifying LEDs, the LEDs each including a combination of an LED element that emits a primary light and phosphor that, upon excitation by the primary light, emits a secondary light having a longer wavelength than the primary light, the LEDs each emitting a combined light of the primary light and the secondary light, those ones of the LEDs whose primary lights have their chromaticities falling within a predetermined chromaticity range being classified as LEDs for use in a backlight of a liquid crystal display apparatus,
the method comprising:
a chromaticity predicting step of predicting, for all of the LEDs to be classified, the chromaticities of the primary lights having traveled through a color filter in a liquid crystal panel provided in the liquid crystal display apparatus; and
a chromaticity rank classification step of classifying the LEDs according to chromaticity rank on a basis of the predicted chromaticities,
the chromaticity predicting step includes a chromaticity correcting step of calculating, for all of the LEDs to be classified, correction values for the chromaticities as based on transmission of the primary lights through the color filter, and of correcting the chromaticities as corrected chromaticities on a basis of the correction values for all of the LEDs to be classified; and
the chromaticity correcting step includes:
a coefficient calculating step of calculating a reference chromaticity as of a time when a primary light having a predetermined reference wavelength has traveled through the color filter and amounts of change in the chromaticities with respect to the reference chromaticity, and of calculating, as coefficients of the correction values for the chromaticities, inclinations of the amounts of change with respect to a shift amount of each of the peak wavelengths of the primary lights from the reference wavelength, respectively; and
a corrected chromaticity calculating step of calculating the correction values by multiplying a difference between the peak wavelength and the reference wavelength by the coefficients, respectively, and of calculating the corrected chromaticities by subtracting the correction values from the chromaticities obtained for all of the LEDs to be classified, respectively.

3. The method as set forth in claim 2, wherein with respect to the liquid crystal display apparatus in which the backlight includes a plurality of linear light sources having a plurality of the LEDs and provided adjacent to each other and a light guide plate having at least one edge side on which emitted lights from the linear light sources are incident and planarly radiating the emitted lights onto the liquid crystal panel, the coefficient calculating step includes calculating the coefficients so that the chromaticities of transmitted lights obtained as a result of the emitted lights from the respective linear light sources having traveled through the light guide plate and then through the liquid crystal panel match in a position closer to a light entrance side of the light guide plate than a central part between an edge of the light guide plate on the light entrance side and an edge of the light guide plate opposite to the light-entrance-side edge.

4. The method as set forth in claim 3, wherein the coefficient calculating step includes calculating the coefficients so that a difference in chromaticity between the transmitted lights in the central part is 3/1000 or smaller.

5. The method as set forth in claim 2, wherein the primary lights are blue lights.

6. (canceled)

7. An LED classification device for classifying LEDs, the LEDs each including a combination of an LED element that emits a primary light and phosphor that, upon excitation by the primary light, emits a secondary light having a longer wavelength than the primary light, the LEDs each emitting a combined light of the primary light and the secondary light, those ones of the LEDs whose primary lights having their chromaticities falling within a predetermined chromaticity range being classified as LEDs for use in a backlight of a liquid crystal display apparatus,
the LED classification device comprising:
a chromaticity predicting section for predicting, for all of the LEDs to be classified, the chromaticities of the primary lights having traveled through a color filter in a color filter provided the liquid crystal display apparatus; and
a chromaticity rank classification section for classifying the LEDs according to chromaticity rank on a basis of the predicted chromaticities,
the chromaticity predicting section includes a chromaticity correcting section for calculating, for all of the LEDs to be classified, correction values for the chromaticities as based on transmission of the primary lights through the color filter, and for correcting the chromaticities as corrected chromaticities on a basis of the correction values for all of the LEDs to be classified; and
the chromaticity correcting section includes:
a coefficient calculating section for calculating a reference chromaticity as of a time when a primary light having a predetermined reference wavelength has traveled through the color filter and amounts of change in the chromaticities with respect to the reference chromaticity, and for calculating, as coefficients of the correction values for the chromaticities, inclinations of the amounts of change with respect to a shift amount of each of the peak wavelengths of the primary lights from the reference wavelength, respectively; and
a corrected chromaticity calculating section for calculating the correction values by multiplying a difference between the peak wavelength and the reference wavelength by the coefficients, respectively, and for calculating the corrected chromaticities by subtracting the correction values from the chromaticities obtained for all of the LEDs to be classified, respectively.

8. The LED classification device as set forth in claim 7, wherein with respect to the liquid crystal display apparatus in which the backlight includes a plurality of linear light sources having a plurality of the LEDs and provided adjacent to each other and a light guide plate having at least one edge side on which emitted lights from the linear light sources are incident and planarly radiating the emitted lights onto the liquid crystal panel, the coefficient calculating section calculates the coefficients so that the chromaticities of transmitted lights obtained as a result of the emitted lights from the respective linear light sources having traveled through the light guide plate and then through the liquid crystal panel match in a position closer to a light entrance side of the light guide plate than a central part between an edge of the light guide plate on the light entrance side and an edge of the light guide plate opposite to the light-entrance-side edge.

9. The LED classification device as set forth in claim 8, wherein the coefficient calculating section calculates the coefficients so that a difference in chromaticity between the transmitted lights in the central part is 3/1000 or smaller.

10. The LED classification device as set forth in claim 7, wherein the primary lights are blue lights.

11. (canceled)

12. A non-transitory computer-readable storage medium having stored therein an LED classification program causing a computer to function as each of the sections of an LED classification device as set forth in claim 7.

13. A liquid crystal display apparatus comprising:
a liquid crystal panel;
a plurality of linear light sources having a plurality of LEDs and provided adjacent to each other;
a light guide plate having at least one edge side on which emitted lights from the linear light sources are incident and planarly radiating the emitted lights onto the liquid crystal panel,
the LED being selected by an LED classification method as set forth in claim 2 to be mounted on the linear light sources so that the chromaticities of transmitted lights obtained as a result of the emitted lights from the respective linear light sources having traveled through the light guide plate and then through the liquid crystal panel match in a position closer to a light entrance side of the light guide plate than a central part between an edge of the light guide plate on the light entrance side and an edge of the light guide plate opposite to the light-entrance-side edge.

14. The liquid crystal display apparatus as set forth in claim 13, wherein the position in which the chromaticities match is a position at a distance, from the light-entrance-side edge, of 40% or more to less than 50% of a distance between the light-entrance-side edge and the central part.
